(19) United States
(12) Patent Application Publication
(10) Pub. No.: US 2024/0072237 A1
(43) Pub. Date: Feb. 29, 2024

(54) HIGH TEMPERATURE LITHIUM-ION BATTERY AND METHOD OF MAKING SAME

(71) Applicant: Wayne State University, Detroit, MI (US)

(72) Inventors: Leela Mohana Reddy Arava, Troy, MI (US); Sathish Rajendran, Detroit, MI (US)

(21) Appl. No.: 18/238,648

(22) Filed: Aug. 28, 2023

Related U.S. Application Data
(60) Provisional application No. 63/401,755, filed on Aug. 29, 2022.

(51) Int. Cl. H01M 4/131; H01M 4/04; H01M 4/136; H01M 10/0525; H01M 10/0567; H01M 10/0569; H01M 10/0587; H01M 50/107

(52) U.S. Cl. CPC H01M 4/131; H01M 4/0416; H01M 4/136; H01M 10/0525; H01M 10/0567; H01M 10/0569; H01M 10/0587; H01M 50/107

(57) ABSTRACT

A high temperature Li-ion rechargeable battery capable of operating in the temperature range of 60 to 100° C. is disclosed. The Li-ion battery includes a cathode, an anode, an electrolyte in contact with the cathode and with the anode, and a separator positioned between the cathode and the anode and having the electrolyte to either side of the separator. The cathode includes one of LiFePO₄ (LFP), a composition of LiNiₓMn_{y}Co_{z}O₂ (NMC), a composition of LiNiₓCo_{y}Al_{1-y}O₂ (NCA), and a composition of LiMnₓNi₂₋ₓO₄ (LMO/LMNO). The anode includes one of Li4Ti5O12 (LTO), graphite, Silicon, and a composite of silicon. The separator is one of polypropylene, quartz, and glass fiber. The electrolyte a Lithium salt and a solvent. The solvent is a room temperature ionic liquid (RTIL) with or without additives and/or diluents.

### CROSS-REFERENCE TO RELATED APPLICATIONS

This application claims priority to U.S. Prov. App. No. 63/401,755 filed on Aug. 29, 2022, the contents of which are hereby incorporated by reference in its entirety.

### TECHNICAL FIELD

This disclosure relates generally to a rechargeable battery, particularly a lithium ion (Li-ion) battery exhibits high temperature stable cyclability, such as up to 100° C. with low self-discharge and low internal resistance.

### BACKGROUND

The demand for lithium ion (Li-ion) batteries is steadily growing, and zero carbon goals for achieving a safe and sustainable society have led to intensive research on developing high performance battery materials. Conventional applications of Li-ion batteries include portable electronics, electric vehicles, and grid energy storage. With the current Li-ion technology, batteries may be safely operated between approximately room temperature to 45° C., and operation beyond this suggested temperature range may lead to irreversible degradation and catastrophic failures such as fires and explosions.

Energy storage by Li-ion technology is one of the key strategies for achieving a viable transformation of fossil fuel dominance to sustainable energy sector. Currently, there is a great hope in the Li-ion technology that has already dominated the portable electronic industry and the rapid growth in electric vehicles. Li-ion batteries possess high energy/power density and long cycle life when compared to other battery chemistries. Conventional application of Li-ion batteries include portable electronics, electric vehicles, and grid energy storage. Most of these applications involve working temperature 0 to 45° C. for which these batteries are designed. Beyond 45° C. the batteries need a thermal cooling system to keep the battery functioning.

Apart from the conventional application, there are several applications that involve extreme temperature application that are in need for high energy density Li-ion rechargeable batteries. For example, in the field of medical industry, wireless powered medical devices need to be sterilized periodically at high temperature. In both cases, the batteries are degraded by high temperatures. In another case, the oil and gas industry sector batteries to monitor and power up sensor application during downhole operations. In some industrial applications, safety applications such as camera and alarms, which must be operated at extreme environments. Also, military applications such as security drones and other high temperature devices will be powered by high temperature batteries. With these multifarious objectives of high temperature batteries, the current high temperature battery materials are emerging and typically include a real breakthrough in high temperature and rechargeable battery chemistry to overcome the dominance of hazardous primary Li-ion battery technologies.

Conventional Li-ion batteries may possess electrodes that are not stable at high temperature, electrolyte that decomposes beyond 50° C., separator that shrinks above 60° C.

The self-discharge may also accelerate when the operating temperature is increased. Overall, high-temperature operation of conventional Li-ion batteries may result catastrophic with the flammable organic liquid electrolyte.

The battery pack can also undergo thermal runaway when one of the battery short-circuits. Hence, conventional Li-ion batteries cannot be used in harsh environmental conditions.

State-of-the art batteries for harsh environments typically utilize primary Li-ion battery chemistries such as Li-thionyl chloride (Li—SOCl₂) that can operate up to 100° C. but may not possess rechargeable capabilities. These primary batteries often include periodic replacements after being completely discharged, which not only adds complexity in operation but also adds cost. Moreover, this constant care during operation can lead to huge maintenance task and environmental impact of spent electronic battery materials waste. To date, several research groups have investigated the high temperature compatibility of Li-ion rechargeable batteries using functional electrolyte additives, solvent engineering, and electrolyte design strategies. However, successful implementation of rechargeable Li-ion battery chemistry at high temperature operation is thwarted by many technical bottlenecks such as thermal stability and interfacial stability of the electrode and electrolyte materials. Hence, there exists a critical need for the replacement of current primary batteries with rechargeable Li-ion batteries that can be operated at high temperatures.

The current state-of-the art batteries for harsh environments utilizes primary Li-ion battery chemistries such as Li-thionyl chloride (Li—SOCl₂) that can operate up to 100° C. but doesn't possess rechargeable capabilities. These primary batteries include periodic replacements after being completely discharged, which not only adds complexity in operation but also adds cost. Moreover, this constant care during operation leads to huge maintenance tasks and environmental impact of spent electronic battery materials waste.

To date, several research groups have investigated the high temperature compatibility of Li-ion rechargeable batteries using functional electrolyte additives, solvent engineering, and electrolyte design strategies. However, successful implementation of rechargeable Li-ion battery chemistry at high temperature operation is thwarted by many technical bottlenecks such as thermal stability and interfacial stability of the electrode and electrolyte materials. Hence, there exists a critical need for the replacement of current primary batteries with rechargeable Li-ion batteries that can be operated at high temperatures. There are hardly any rechargeable Li-ion batteries available in the market that work in harsh environmental condition beyond 60° C. Development of such batteries can replace the usage of primary batteries. Solid polymer electrolyte-based batteries are available (Seeo's DryLite batteries), but the highest working temperature is only 70° C.

In view of the problem mentioned, there is a need for improved Li-ion batteries that are rechargeable and compatible with high temperature operation.

According to the present disclosure, there is provided a high temperature rechargeable lithium ion battery and method of making the same, as set forth in the appended claims.

### SUMMARY

The disclosure provides rechargeable capabilities for the high-temperature battery applications that results in lower maintenance cost. The rechargeable lithium ion (Li-ion) battery disclosed herein exhibits stable cyclability up to 100° C. with low self-discharge and low internal resistance.

According to a first aspect, there is provided a lithium ion battery that includes a thermally stable cathode, a thermally stable anode, an electrolyte in contact with the cathode and with the anode, and a separator positioned between the cathode and the anode and having the electrolyte to either side of the separator.

Pursuant to an implementation, the cathode comprises a composite including one of LiFePO₄ (LFP), LiNiₓMn_{y}Co_{z}O₂ (NMC), LiNiₓCo_{y}Al_{1-y}O₂ (NCA), and LiMnₓNi₂₋ₓO₄ (LMO/LMNO).

The cathode may optionally include dopants such as Zr, Al, B, Te, F, Mg, Cr, Ti, Ca, W, and Mo.

Additionally or alternatively, the anode comprise a composite including one of Li4Ti5O12 (LTO), graphite, and silicon.

The separator may include one of polypropylene, quartz, and glass fiber.

Pursuant to an implementation, the electrolyte is a lithium salt and a room temperature ionic liquid (RTIL). The lithium salt may include lithium bis(trifluoromethanesulfonyl)imide (LiTFSI) or lithium bis(fluorosulfonyl)imide (LiFSI). The RTIL may include at least one of pyrrolidinium, piperidinium, imidazolium, and phosphonium ionic liquids.

The electrolyte may include an additive and/or a diluent, having a lower viscosity than the RTIL. The additive and/or diluent may be an organic solvent and/or an inorganic salt. In particular, for example, the electrolyte includes the addition of propylene carbonate and/or tetrahydrofuran. The amount of diluent and/or additive may range from 0.1% to 50% by weight of the electrolyte.

Pursuant to a second aspect, there is provided a method of making a rechargeable lithium ion battery. The method includes providing an anode and a cathode; positioning the anode and the cathode inside a cell case, wherein the anode and the cathode are separated by a separator; filling the inside of the cell case with an electrolyte so that the electrolyte wets and contacts the anode and the cathode; and sealing the case. The electrolyte may comprise a lithium salt and a room temperature ionic liquid (RTIL) solvent.

The RTIL solvent may include at least one of pyrrolidinium, piperidinium, imidazolium, and phosphonium ionic liquids.

Pursuant to an implementation, the electrolyte may include an organic solvent and/or an inorganic salt.

Pursuant to an implementation, the cathode may be formed by slurry coating a cathode composite material onto a current collector (e.g., an aluminum foil). The cathode composite material includes a cathode active material, a conducting carbon powder, and a binder in a predefined ratio. The cathode active material may be chosen from LiFePO₄ (LFP), LiNiₓMn_{y}Co_{z}O₂ (NMC), LiNiₓCo_{y}Al_{1-y}O₂ (NCA), and LiMnₓNi₂₋ₓO₄ (LMO/LMNO).

Additionally or alternatively, the anode may be formed by slurring coating an anode composite material onto a metal plate (e.g., a copper foil). The anode composite material includes an anode active material, a conducting carbon powder, and a binder in a predefined ratio. The anode active material may include Li₄Ti₅O₁₂ (LTO), silicon, or graphite.

### BRIEF DESCRIPTION OF THE DRAWINGS

FIG. 1 is a schematic illustration of a lithium-ion battery according to the disclosure.

FIG. 2 is a digital image of the separator, conformal electrode composite coating on the copper and carbon coated aluminum current collector compared with the scale bar of a ruler in inch scale.

FIG. 3A is a digital image of rolled electrodes and separator in the ungrooved cylindrical cell.

FIG. 3B is a schematic illustration comparing the fabricated AA format (14500) cylindrical cell and a commercial AA alkaline battery.

FIG. 4A illustrates electrochemical impedance spectroscopy (EIS) measured at 100° C. of the fabricated cylindrical cell.

FIG. 4B illustrates galvanostatic charge-discharge of the cylindrical cell at 100° C. using a constant current of 20 mA.

FIGS. 5A-5C illustrate electrochemical performance of the disclosed battery cell of FIG. 1 including room temperature ionic liquid (RTIL) electrolyte with additive(s) and/or diluent(s).

FIG. 6 is a flowchart showing a method of forming a rechargeable high temperature lithium-ion battery, which demonstrates high temperature stable cyclability, such as up to 100° C., with low self-discharge and low internal resistance.

### DESCRIPTION

Referring now to the discussion that follows and the drawings, illustrative approaches to the disclosed systems and methods are described in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive, otherwise limit, or restrict the claims to the precise forms and configurations shown in the drawings and disclosed in the following detailed description.

The disclosure relates generally to a technology where a Li-ion battery exhibits stable cyclability up to 100° C. with low self-discharge and low internal resistance.

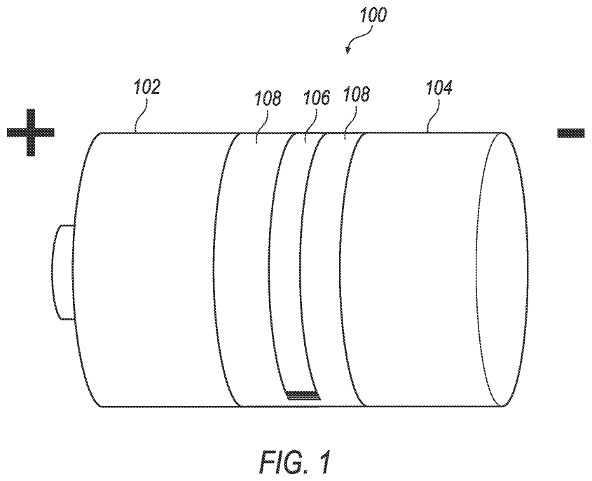

Referring now to the drawings, FIG. 1 shows a schematic illustration of a lithium-ion battery 100 according to the disclosure. The battery 100 includes a thermally stable cathode 102. The thermally stable cathode 102 may comprise a material including, but not limited to, LiFePO₄ (LFP), a variety of compositions of LiNiₓMn_{y}Co_{z}O₂ (NMC) where x+y+z=1 (e.g., NMC333 where the composition is LiNi_{0.33}Mn_{0.33}Co_{0.33}O₂), compositions of LiNiₓCo_{y}Al_{1-y}O₂ (NCA), and compositions of LiMnₓNi₂₋ₓO₄ (LMO/LMNO), all of which compositions may be provided with or without dopants (e.g., B, Zr, Al, Te, F, Mg, Cr, Ti, Ca, W, Mo). Doping or dopant refers to adding a small number of heteroatoms that are incorporated into the crystal structure of the host (e.g., up to 1%), without the appearance of additional phases. The provision of doping the cathode compositions has been shown as an effective method to stabilize the surface of lithiated Ni-rich oxides and facilitates high stability with long-term cyclability. For example, Zr-doped NMC increases the structural stability of Ni-rich materials and enhances the thermal stability of the electrode material. Mo- and Al-doped Ni-rich materials facilitate improvements in thermal stability at higher operating temperatures as compared to undoped counterparts. The doping may be performed during synthesis or lithiation.

The battery 100 includes a thermally stable anode 104. The thermally stable anode 104 may comprise a material including, but not limited to, Li₄Ti₅O₁₂ (LTO), graphite, silicon (Si) or their composites.

A high temperature separator 106 is provided between the cathode 102 and the anode 104. The separator 106 may comprise a material including, but not limited to, polypropylene, quartz, and glass fiber.

A thermally stable electrolyte 108 is provided on both sides of the separator 106, so that the electrolyte is in contact with the cathode 102 and the anode 104 with the electrolyte 108 on either side of the separator 106. The electrolyte 108 comprises an Li salt and a solvent. Pursuant to the disclosure, the solvent comprises a room temperature ionic liquid (RTIL), with or without suitable additives. The provision of an RTIL electrolyte enables high temperature performance (e.g., above 60° C.) and manufacturing efficiencies due to its viscosity as compared to traditional solvents such as organic liquid electrolytes.

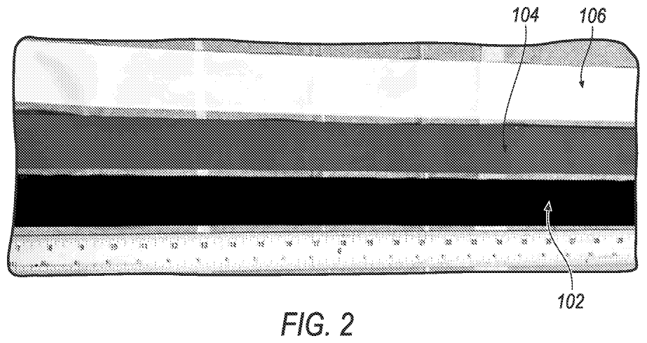

Among various electrode materials for the cathode 102 and anode 104, electrodes with high thermal stability are used for the disclosed battery 100, including the cathode and anode materials described above. The electrodes may be prepared in an argon-filled glovebox using a slurry coating method. Pursuant to an implementation, the cathode 102 is LiFePO₄ (LFP) and the anode 104 is Li₄Ti₅O₁₂ (LTO). The cathode composite includes active material (e.g., cathode powder of LFP), a conducting carbon (e.g., C-65 carbon black powder), and binder (e.g., polyvinylidene fluoride (PVDF)) in the weight ratio of 80:15:5. The composite was made into a slurry using N-Methylpyrrolidone (NMP) solvent in a vacuum mixture and coated on a current collector (e.g., a carbon coated aluminum foil). The anode composite includes active material (e.g., anode powder), a conducting carbon (e.g., C-65), and a binder (e.g., PVDF) in the weight ratio of 87:8:5. The weight ratio of the components of the anode and cathode are not limited to the stated composition and can be varied according to the battery performance that is desired. The carbon content can be varied to adjust the electronic conductivity of the electrodes, binder content can be varied to adjust the binding between the electrode and the current collector. The composite was made into a slurry using NMP solvent and coated on a metal plate (e.g., copper foil). Both electrodes were dried at 100° C. for 8 hours. After the drying process, the back side of the electrode was coated and dried using the same procedure. The dried double-side coated electrodes were cut into rectangular shapes of suitable length and width with regards to the AA cell (14500). The tabs were spot welded to the current collector. A digital image showing the conformal coating of the composite material on the current collector is shown in FIG. 2. The shape and size of the components is not limiting and can be adapted to any battery form factor like pouch cells of various capacities, coin cells of different dimensions, cylindrical cells of various dimensions like 18650, 14500, 4680, etc.

Electrolyte: Electrolyte is an important component that will enable high temperature performance. A Li-ion battery electrolyte contains a lithium salt, which is dissolved in a solvent. Conventionally, the organic liquid electrolytes in current Li-ion batteries may deliver stable performance between room temperature to 60° C., as severe capacity degradation is typically observed for storage and/or cycling at high temperatures. The high temperature compatibility of Li-ion rechargeable batteries using functional electrolyte additives, solvent engineering, and electrolyte design strategies are disclosed. However, the intrinsic physicochemical properties such as flammability, high volatility, thermal stability, and low flash point and melting temperature may restrict the implementation of the carbonate electrolytes to explore current battery materials at high temperature applications. The present disclosure utilizes a thermally stable electrolyte comprising lithium salt and room temperature ionic liquids (RTILs) that are suitable solvents for high-temperature operation and are RTILs that are thermally stable up to 300° C. RTILs possess physicochemical properties such as non-volatility, non-flammability, a wide liquidus range and high conductivity. RTILs contemplated herein include electrochemically stable, less viscous RTIL with pyrrolidinium, piperidinium, imidazolium, phosphonium, and ammonium-based cations and hexafluoro phosphate (PF6), bis(trifluoromethanesulfonyl)imide (TFSI), bis(fluorosulfonyl)imide (FSI)-based anions can be used along with suitable electrolyte additives and diluents such as carbonate (e.g., propylene carbonate) and ether solvents. Among different lithium salts, salts with high thermal stability can be chosen such as lithium bis(trifluoromethanesulfonyl)imide (LiTFSI) and lithium bis(fluorosulfonyl)imide (LiFSI). Pursuant to an example, the electrolyte comprises LiTFSI salt dissolved in pyrrolidinium based 1-butyl 1-methyl pyrrolidinium bis trifluoro methane sulfonimide (Pyr₁₄TFSI) ionic liquid, with or without additive(s) and diluent(s).

Separator: Several separators were tested for their high temperature compatibility. Out of different separators, the polypropylene, quartz, and glass fiber separators were stable at elevated temperatures and are able to wet the RTIL electrolyte. The choice of separator can be based on the cell form factor.

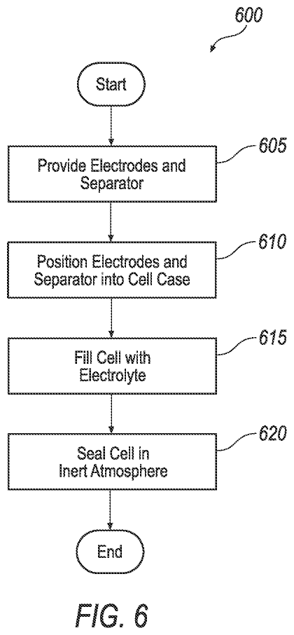

Referring to FIG. 6, a method 600 of making a rechargeable lithium-ion battery, which demonstrates high temperature stable cyclability, such as up to 100° C. or greater, with low self-discharge and low internal resistance, is shown. At step 605, the electrodes 102, 104 and separator 106 are provided. The electrodes 102, 104 may be provided (e.g., formed) as discussed above. For example, the cathode 102 may be formed by providing a composite composition including cathode active material (e.g., LFP, NMC, NCA, or LMO/LMNO), a conducting carbon (e.g., C-65 carbon black powder), and binder (e.g., PVDF) in a predefined weight ratio (e.g., 80:15:5), mixing the cathode composite into a slurry using NMP solvent (e.g., in a vacuum or Argon filled glovebox), and then coating the cathode slurry onto a current collector (e.g., a carbon coated aluminum foil). The anode 104 may be formed by providing a composite composition including anode active material (e.g., LTO, silicon, or graphite), a conducting carbon (e.g., C-65), and binder (e.g., PVDF) in a predefined weight ratio (e.g., 87:8:5), mixing the anode composite into a slurry using NMP solvent, and then coating the anode slurry onto a metal substrate or plate (e.g., copper foil). The coated electrodes are dried at 100° C. for 8 hours. After the drying process, the back side of the electrodes are coated and dried using the same procedure. Alternatively, both sides of the electrodes may be coated and dried at the same time. For the separator, a high temperature material, e.g., a quartz or polypropylene membrane, may be used which may vary depending on the cell form factor. The electrodes and separator are then cut into a predetermined shape (e.g., rectangular) and size (length and width) determined by cell type.

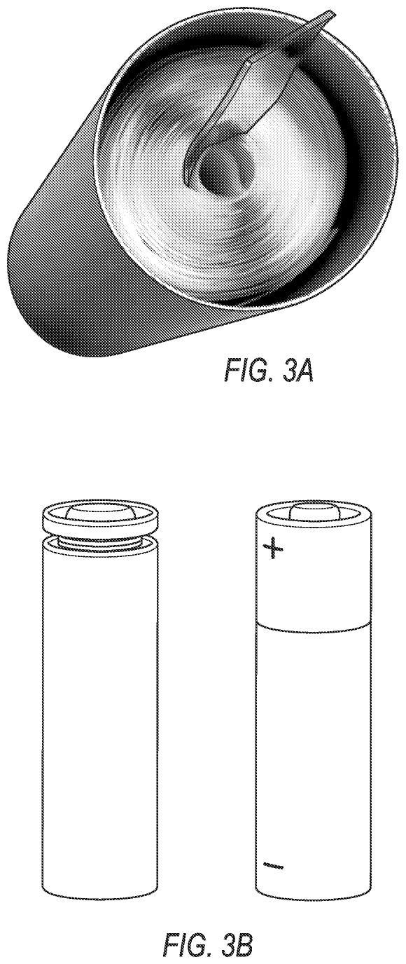

At step 610, the electrodes 102, 104 and the separator 106 are positioned or mounted into a cell case (e.g., a stainless steel cylindrical case). In the example of a cylindrical cell (AA size/14500 format), the electrodes 102, 104 along with their respective tabs are rolled along with the separator 106. The rolled cell assembly is placed inside a cylindrical cell case. This disclosure can be extended to any battery form factor like pouch cells of various capacities, coin cells of different dimensions, cylindrical cells of various dimensions like 18650, 14500, 4680, etc., and thus is not limited to a cylindrical cell of AA size as shown in the examples. FIG. 3A shows the rolled cell assembly (rolled electrodes with separator) in an ungrooved cylindrical cell case with the aluminum tab (cathode tab) pointing upwards. It will be appreciated that the anode (negative) tab is positioned on the opposite thereto and welded to the negative side (e.g., bottom end) of the cell. The cell case may then be grooved using a grooving machine, e.g., so that a circumferential/annular groove is formed at the positive end, to fix the rolled cell assembly in the cell case (see FIG. 3B for grooved cell case).

At step 615, a thermally stable electrolyte is prepared (e.g., Li-salt and RTIL solvent, with or without additives and/or diluents) and filled into the case interior after transferring the cell to an argon filled glovebox. According to the disclosure, the electrolyte comprises an Li-salt and RTIL solvent, with or without additives and/or diluents. Pursuant to an implementation, an organic solvent and/or an inorganic salt is/are added to the RTIL solvent to enhance thermal stability to improve cell cycling with minimum capacity loss, as discussed further below. After filling the interior of the cell with the electrolyte, the cell may then be subjected to a low vacuum for a predetermined time (e.g., 2 minutes) for the electrolyte to seep into the electrode/separator. The electrolyte according to the disclosure facilitates the filling process due to the low viscosity of the RTIL solvent relative to conventional organic liquid electrolytes, thereby greatly reducing the time required for the electrolyte to seep into the electrodes and separator to achieve gains in manufacturing efficiencies. This may be further facilitated by the additive and/or diluent, which may be composed of a material that has a lower viscosity than the RTIL, thereby improving the filling process and contacting the electrolyte with the anode and the cathode.

After the electrolyte filing step, at step 620 the cell is sealed with a cover in an inert atmosphere (e.g., an argon filled glovebox). Electrolyte filling can be done in different methods and atmospheres using an electrolyte diffusion chamber, vacuum filling, etc. either in a glovebox with argon/nitrogen, or in a dry room with controlled humidity. FIG. 3B shows the comparison between the disclosed battery cell in the form of a AA cylindrical battery and a commercial AA alkaline battery.

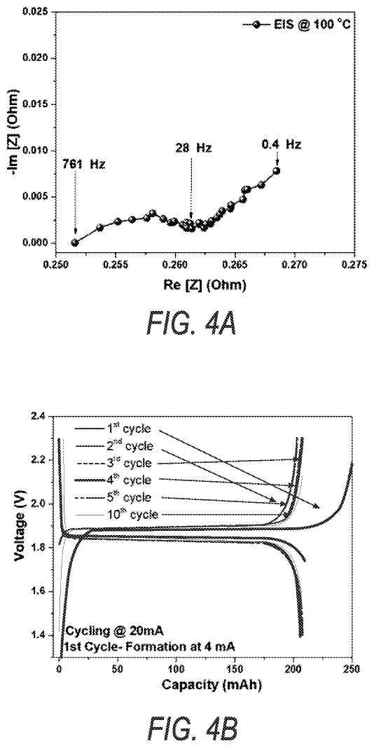

The self-discharge of a lithium-ion battery depends on its internal resistance. The internal resistance of the fabricated cylindrical cell was evaluated using electrochemical impedance spectroscopy (EIS). EIS was performed from a frequency of 800 Hz to 100 mHz in the galvanostatic mode using 5 mA as the amplitude current, as shown in FIG. 4A. The internal resistance of the battery was found to be 251.5 mΩ at 100° C. Such low internal resistance value will have a low tendency to lose its charged ions from one electrode to the other, which results in self-discharge. The charge transfer resistance of the battery was found to be 12 mΩ, which indicates the smooth ion transfer in-between the electrodes. The low frequency Warburg impedance was found to be 45° inclined to the x-axis that indicates the perfect diffusion-controlled process.

FIG. 4B illustrates galvanostatic charge-discharge of the cylindrical cell at 100° C. using a constant current of 20 mA. The cyclability of the cylindrical cell was performed through galvanostatic charge-discharge studies at 100° C. The first cycle of the battery, known as the formation cycle, was performed at 4 mA current with a charging cut-off voltage 2.2 V and discharge cut-off voltage 1.73 V. The charge and discharge capacity during the formation cycle was found to be 250 mAh and 210 mAh, respectively, with a coulombic efficiency of 84%. Subsequent cycling was performed at 20 mA current with a cut-off voltage of 2.3 V and 1.4 V during charge and discharge, respectively. The subsequent cycling from the 2nd cycle to the 10th cycle exhibited a constant discharge capacity of 206 mAh with an average coulombic efficiency of 99.85%. The metric shows ultra-stable performance at 100° C. The voltage plateau/polarization curve was found to overlap with each other with no indication of increase in polarization of the fabricated cylindrical cell. The polarization was low during the 1st cycle because of the use of low current for the formation cycle.

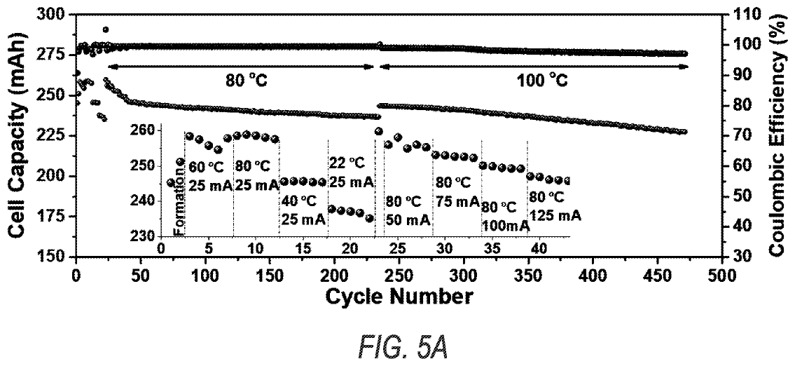

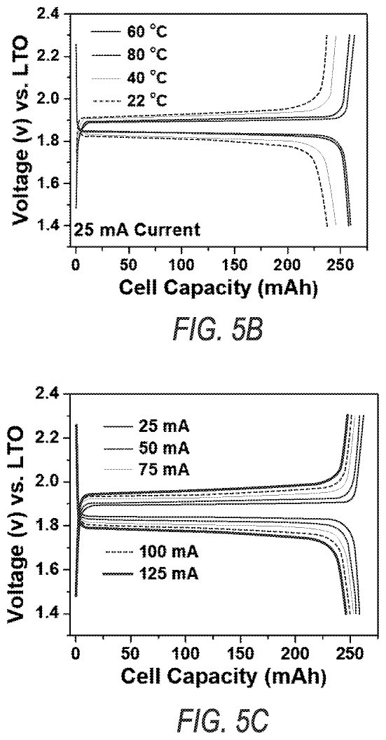

With the addition of additives and diluents to the RTIL electrolyte such as organic solvents and inorganic salt, the cell can be tuned to perform at a wide temperature range of operation and faster charging rate. The additive and diluent can be a material that possess lower viscosity than the RTIL. The additive can also provide additional electrochemical stability to the RTIL electrolyte. The amount of additive can vary from 0.1% to 50% by weight of the electrolyte depending on its properties. Some examples of the solvents that can be used are carbonates including, but not limited to, ethylene carbonate, propylene carbonate, fluoroethylene carbonate, vinylene carbonate, ethyl methyl carbonate, dimethyl carbonate, as well as acetonitrile and tetrahydrofuran. The inorganic salt can be any additive in the form of oxides, nitrates, halides, nitrides, sulfides, sulfates, and carbonates that forms an artificial layer over the cathode surface by preferentially decomposing at higher voltages that the cathode experiences. An example is shown in FIGS. 5A, 5B, and 5C, where the cell 100 includes propylene carbonate additive and tetrahydrofuran diluent. The cell was cycled at temperatures ranging from 22° C. to 100° C. (FIG. 5B) and at currents from 25 mA to 125 mA (FIG. 5C). The cell exhibited very low polarization at a wide range of temperature and currents. The cell also was subjected to longer cycling for over 475 cycles and the cell exhibited more than 90% capacity retention. The additive(s) and diluent(s) were able to provide additional electrochemical stability to the electrolyte along with reduced viscosity and improved ionic mobility that helps in the better performance of the cell.

The above results demonstrate stable cyclability of cylindrical cells at harsh environmental conditions and can be extended to other form factors of Li-ion battery, like the pouch cell and coin cell. The reproducibility of the results was verified by testing multiple batteries. Thus, the present disclosure is battery technology that achieves high temperature battery operation. This technology can be used in any format of Li-ion batteries currently available in market, such as coin cell, pouch cell, cylindrical cell. Hence, the term “other form factors” is used to ensure the disclosure is not limited to the type of battery used in the demonstrated results.

There are very few rechargeable Li-ion batteries available in the market that work in harsh environmental condition beyond 60° C. Development of such batteries can replace the usage of primary batteries. Solid polymer electrolyte-based batteries are available (Seeo's DryLite batteries), but the highest working temperature is limited to 70° C.

The Table below summarizes a list of exemplary competing technologies.

| | Safety Reliability | Rechargeability | Temperature | |
|---|---|---|---|---|
| Electrochem | Lithium thionyl chloride | No | <150° | C. |
| | (Corrosive, explosive, HAZMAT) | | | |
| Saft | Lithium thionyl chloride | Limited | <150° C. (non-rechargeable) | |
| | (corrosive, explosive, HAZMAT) | | <125° C. (limited to 30 re- | |
| | | | chargeable cycles @ 125° C.) | |
| Seeo | Solid polymer electrolyte (no | Yes | <70° | C. |
| | flammable or volatile components) | | | |
| Seiko | Lithium cobalt oxide cathode and | Yes | <85° | C. |
| | Lithium titanate anode | | | |
| Tadiran | Lithium thionyl chloride | No | <130° | C. |
| | (Corrosive, explosive, HAZMAT) | | | |

Thus, according to the disclosure, Li-ion batteries as described herein possess high energy/power density and long cycle life when compared to other battery chemistries. Conventional application of Li-ion battery includes portable electronics, electric vehicles, and grid energy storage. Most of these applications involve working temperature 0 to 45° C. for which these batteries are designed. Beyond 45° C. the batteries need a thermal cooling system to keep the battery functioning. Apart from the conventional application, there are several applications that involve extreme temperature application that are in need for high energy density Li-ion rechargeable batteries. For example, in the field of medical industry, wireless powered medical devices need to be sterilized periodically at high temperature. In another case, the oil and gas industry sector require batteries to monitor and power up sensor application during downhole operations. In some industrial applications, safety applications such as camera and alarms that must be operated at extreme environments. Also, military applications such as security drones and other high temperature devices will be powered by high temperature batteries. With these multifarious objectives of high temperature batteries, the current high temperature battery materials are emerging and require a real breakthrough in high temperature and rechargeable battery chemistry to overcome the dominance of hazardous primary Li-ion battery technologies. The current state-of-the art batteries for harsh environments utilizes primary Li-ion battery chemistries such as Li-thionyl chloride that can operate up to 100° C. but doesn't possess rechargeable capabilities. These primary batteries require periodic replacements after being completely discharged, which not only adds complexity in operation but also adds cost. Moreover, this constant care during operation leads to huge maintenance task and environmental impact of spent electronic battery materials waste.

The present disclosure is related to high temperature Li-ion rechargeable batteries capable of operating in the temperature range of up to 100° C., particularly 60° C. to 100° C., and are non-flammable. These batteries are made by carefully designing individual components of the conventional battery, like the electrode, electrolyte, and separator to enable high temperature operation and low-self-discharge capabilities.

Several applications include medical industry, where the wireless powered medical devices need to be sterilized periodically at high temperature. In another case, the oil and gas industry sector require batteries to monitor and power up sensor application during downhole operations. In some industrial applications, safety applications such as camera and alarms that must be operated at extreme environments. Also, military applications such as security drones and other high temperature devices will be powered by high temperature batteries. With these multifarious objectives of high temperature batteries, the current high temperature battery materials are emerging and require a real breakthrough in high temperature and rechargeable battery chemistry to overcome the dominance of hazardous primary Li-ion battery technologies.

The disclosure has the following advantages:
Rechargeable Capabilities
Better safety, non-flammable technology
Low self-discharge
Long cycle-life

When introducing elements of various embodiments of the disclosed materials, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While the preceding discussion is generally provided in the context of Lithium ion batteries, it should be appreciated that the present techniques are not limited to such limited contexts. The provision of examples and explanations in such a context is to facilitate explanation by providing instances of implementations and applications. The disclosed approaches may also be utilized in other contexts or configurations.

All matter contained in the above description or shown in the accompanying drawings shall be interpreted as illustrative only and not limiting. Changes in detail or structure may be made without departing from the present disclosure.

While the disclosed materials have been described in detail in connection with only a limited number of embodiments, it should be readily understood that the embodiments are not limited to such disclosed embodiments. Rather, that disclosed can be modified to incorporate any number of variations, alterations, substitutions, or equivalent arrangements not heretofore described, but which are commensurate with the spirit and scope of the disclosed materials. Additionally, while various embodiments have been described, it is to be understood that disclosed aspects may include only some of the described embodiments. Accordingly, that disclosed is not to be seen as limited by the foregoing description but is only limited by the scope of the appended claims.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary. Further, the use of “at least one of” is intended to be inclusive, analogous to the term and/or. As an example, the phrase “at least one of A, B and C” includes A only, B only, C only, or any combination thereof (e.g. AB, AC, BC or ABC). Additionally, use of adjectives such as first, second, etc. should be read to be interchangeable unless a claim recites an explicit limitation to the contrary.

What is claimed is:

1. A lithium ion battery, comprising:
a thermally stable cathode;
a thermally stable anode;
an electrolyte in contact with the cathode and with the anode; and
a separator positioned between the cathode and the anode and having the electrolyte to either side of the separator.

2. The lithium ion battery of claim 1, wherein the cathode includes one of LiFePO₄ (LFP), a composition of LiNiₓMn_{y}Co_{z}O₂ (NMC), a composition of LiNiₓCo_{y}Al_{1-y}O₂ (NCA), and a composition of LiMnₓNi₂₋ₓO₄ (LMO/LMNO).

3. The lithium ion battery of claim 2, wherein the cathode further includes dopants.

4. The lithium ion battery of claim 1, wherein the dopants are chosen from B, Zr, Al, Te, F, Mg, Cr, Ti, Ca, W, and Mo.

5. The lithium ion battery of claim 1, wherein the anode includes one of Li₄Ti₅O₁₂ (LTO), graphite, silicon, and a composite of silicon.

6. The lithium ion battery of claim 1, wherein the separator is one of polypropylene, quartz, and glass fiber.

7. The lithium ion battery of claim 1, wherein the electrolyte comprises a lithium salt and a solvent.

8. The lithium ion battery of claim 7, wherein the solvent is a room temperature ionic liquid (RTIL).

9. The lithium ion battery of claim 8, wherein the RTIL includes at least one of pyrrolidinium, piperidinium, imidazolium, and phosphonium ionic liquids.

10. The lithium ion battery of claim 8, wherein the solvent includes an additive and/or a diluent, the additive and/or the diluent composed of a material that has a lower viscosity than the RTIL.

11. The lithium ion battery of claim 10, wherein the additive and/or the diluent is chosen from a carbonate and an inorganic salt.

12. The lithium ion battery of claim 10, wherein the additive and/or the diluent includes at least one of propylene carbonate and tetrahydrofuran.

13. The lithium ion battery of claim 7, wherein the lithium salt is chosen from lithium bis(trifluoromethanesulfonyl)imide (LiTFSI) and lithium bis(fluorosulfonyl)imide (LiFSI).

14. A method of making a rechargeable lithium ion battery, comprising:
providing an anode and a cathode;
positioning the anode and the cathode inside a cell case, wherein the anode and the cathode are separated by a separator;
filling the inside of the cell case with an electrolyte so that the electrolyte wets and contacts the anode and the cathode; and
sealing the cell case;
wherein the electrolyte comprises a lithium salt and a room temperature ionic liquid (RTIL) solvent.

15. The method of claim 14, wherein the electrolyte includes an additive and/or a diluent including an organic solvent and/or an inorganic salt.

16. The method of claim 14, wherein providing the anode and the cathode includes forming the cathode by slurry coating a cathode composite material onto an aluminum current collector, wherein the cathode composite material includes a cathode active material, a conducting carbon powder, and a binder in a predefined ratio.

17. The method of claim 16, wherein the cathode active material is chosen from LiFePO₄ (LFP), LiNiₓMn_{y}Co_{z}O₂ (NMC), LiNiₓCo_{y}Al_{1-y}O₂ (NCA), and LiMnₓNi₂₋ₓO₄ (LMO/LMNO).

18. The method of claim 14, wherein providing the anode and the cathode includes forming the anode by slurring coating an anode composite material onto a copper plate, wherein the anode composite material includes an anode active material, a conducting carbon powder, and a binder in a predefined ratio.

19. The method of claim 18, wherein the anode active material is Li₄Ti₅O₁₂ (LTO) and the predefined weight ratio is 87:8:5.

20. The method of claim 14, wherein filling the inside of the cell case with the electrolyte is performed in an argon filled glovebox and then subjected to a vacuum for a predetermined time.
